(19) United States
(12) Patent Application Publication
(10) Pub. No.: US 2013/0044582 A1
(43) Pub. Date: Feb. 21, 2013

(54) CONTROL OF END-TO-END DELAY FOR DELAY SENSITIVE IP TRAFFICS USING FEEDBACK CONTROLLED ADAPTIVE PRIORITY SCHEME

(71) Applicant: Faheem Ahmed, Chantilly, VA (US)

(72) Inventor: Faheem Ahmed, Chantilly, VA (US)

(21) Appl. No.: 13/213,852

(22) Filed: Aug. 19, 2011

(51) Int. Cl. H04L 12/26

(52) U.S. Cl. 370/216; 370/236

(57) ABSTRACT

When transporting delay-sensitive traffics such as voice, video and radar data over Internet Protocol (IP), control of end-to-end delay becomes a challenge. Typical approaches tie up bandwidths for entire duration of call. Second thing they do, is prioritization of certain classes over others, to control queuing delays, but this prioritization, remains at class-level and does not go to individual session-levels. As a result certain sessions within a class get more delay than others. Depending upon situation, it can cause adverse effects to certain QoS sessions. In our invention we have developed an intelligent priority scheme which adapts serving priorities of sessions to control ETE delay of each individual QoS session. Priority adapting mechanism is based on feedback control which measures ETE delay of QoS session at destination node and broadcasts it to all nodes along the route of the session to adapt session's priorities to control ETE delay.

### CROSS-REFERENCE TO RELATED APPLICATION

This invention is a continuation of provisional application U.S. Ser. No. 1/376,294 filed on Aug. 24, 2010.

This invention titled “Control of End-to-End Delay of Delay Sensitive IP Traffics Using Feedback Controlled Adaptive Priority Scheme” is done by Dr. Faheem Ahmed, a US citizen residing in Chantilly, Va. This scheme is used to control end-to-end (ETE) delay of delay-sensitive IP traffics at session-level.

### FIELD OF THE INVENTION

This invention deals with the issue of ETE delay in Packet Switched IP Networks, where IP packets of different classes and sessions merge at various nodes and nodes apply certain scheduling policies to serve them. ETE delay, which a packet receives, is the sum of the queuing delays it receives at every node based on scheduling policies and the transmission delays in the transport media. All applications have their own ETE delay requirements. Depending upon the route, IP network provide to these applications' sessions, and other factors, ETE delay each session suffers can vary. One big challenge is to serve each session within its ETE delay requirements.

### BACKGROUND OF INVENTION

There is a growing trend of transporting all types of traffics in IP format, especially the traffics which are delay sensitive. Real time videos over IP, Voice over IP (VoIP), Netmeetings, chat, Instant Messaging (IM), are good examples of this. However we should keep in mind that IP is a Best Effort protocol, meaning no guarantee of delivering the packets and no guarantee with what delay packets will be delivered. Now this is not acceptable for real time and other delay sensitive traffics such radar data, which need to be delivered to the destination in fraction of a second. Commonly used techniques to control delay in such delay sensitive traffics are:
Reserving bandwidths (BW) or resources such as in Resource Reservation Protocols (RSVP), Permanent or Soft Virtual Circuits (PVCs or SVCs), Multi Protocol Label Switching (MPLS) etc.
Classifying and prioritizing traffics such as in DiffServ model or in other priority queue mechanisms etc.

Now, no matter what mechanism we deploy to reserve resources, RSVP, PVC/SVCs or we reserve resources via tunnel like MPLS, one fact is always there that we reserve resources for the entire duration of session, while we use them only for a fraction of time and remaining time they remain unused which is wastage. For example, more than 50% in voice call is silence. More than 90% of the times, radar channel don't have data to send. But no matter what we do, we have to reserve bandwidth for them all the time for such application to transport over IP.

Second fact is, no matter, how we assign resources, there must be a serving queue when there are multiple sessions passing through an interface and when there is queue, there must be some scheduling mechanism. Scheduling mechanism prioritize one kind of traffic over others. We can analyze one scheduling mechanism after another but in all cases, we'll end up with the same conclusion that we (the administrator), assign some rules to the scheduler and scheduler has to follows them blindly.

These scheduling rules do some good but are not good enough to understand and respond to the attitude or nature of these delay sensitive traffics. Let's assume that we are transporting Voice over IP (VoIP) and we assign the highest priority to voice packets, but when there are millions of voice sessions passing through the same interface, then obviously there will be a queue of voice sessions and packets from all voice sessions will be waiting in this highest priority queue. A scheduler in this scenario can not do more than to serve them on First Come First Serve basis. It is quite possible that one call passing through this node is destined to an adjacent city while another call is going to overseas. Now obviously, it would be unfair if the node gives the same level of priority to the packets of the overseas call and local call. Hence there is a need of intelligent mechanism which:
1. Provides control not only to the class level but to the individual session or user level within the class and prioritize them accordingly.
2. Should not reserve resources for the entire duration of session, so that we can use this bandwidth (BW) for other users.

### BRIEF SUMMARY OF INVENTION

Before we go further, for sake of simplicity in the remaining of this document, we will refer delay-sensitive IP traffic as QoS and delay insensitive IP traffic as Non-QoS traffic. The scheme we developed assigns initial set of priorities to each new QoS session at various nodes of its route based on its ETE delay requirements and network congestion conditions. If with this set of priorities, packets of new QoS session can reach their destination within their required ETE delay time, then these priorities are considered optimal and are not changed. However, if the ETE delay objectives of the QoS session are not met, the scheduling or serving priorities of the QoS session are adapted by a feedback mechanism. ETE delays of each QoS session are measured at its destination node. Feedback from the destination node passes this information to all the nodes along the route of that QoS session. As a result, every node adapts the serving priorities of the QoS session to control its ETE delay. Hence, by adapting the scheduling priorities, we control ETE delays of the QoS sessions. So in essence, what our scheme does is:
1. It provides necessary mechanism to adapt priorities of each individual user or session according to their delay requirements in order to control ETE delay.
2. It controls ETE delay without reserving resources for entire duration of the session.
3. It provides control not only to the class-level but to the individual user or session-level.

Following are the steps Feedback Controlled Adaptive Priority Scheme does in order to control ETE delay.
1. New QoS connection is granted by Call Admission Control (CAC) on a path where initial bandwidth (BW) is available and also ETE delay for the sample or Test Packets [See definition in Detail Section] of the new QoS session do not increase ETE delay requirement of the session. We divide Required ETE Delay (RETED) of the new session in accordance with the delay Test Packets bear at different hops of its route and call them as Reference Delays of the QoS session for those nodes. For practical purpose, instead of dividing entire RETED, we divide x.RETED, where x<1, one reason besides some others is to leave some room for reassembly of packets at destination nodes.
2. Minimum and maximum Reference Delay limits for the session at every node are defined.
3. Each node serves multiple QoS sessions with every session having unique value of its reference delay. Using these unique reference delay values, unique serving priorities to every QoS sessions are assigned.
4. Destination node of every QoS session measures ETE delay of delivered packets and periodically broadcast this to all the nodes of the route of the session.
5. Each node based on this feedback information runs algorithm to adjust the serving priority of each QoS session if it is getting delayed or served too early.

### DESCRIPTION OF DIAGRAMS

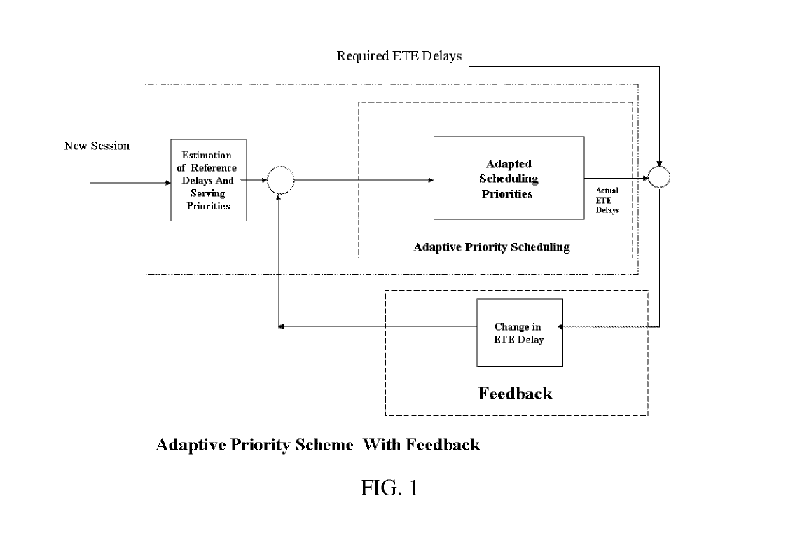

FIG. 1 shows a block diagram of Feedback Controlled Adaptive Priority Scheme. Destination node measures ETE delay of delivered packets. When ETE delay of delivered packets cross the limits of threshold values it sends signal to previous nodes to adapt the serving priorities of this session to control its ETE Delay.

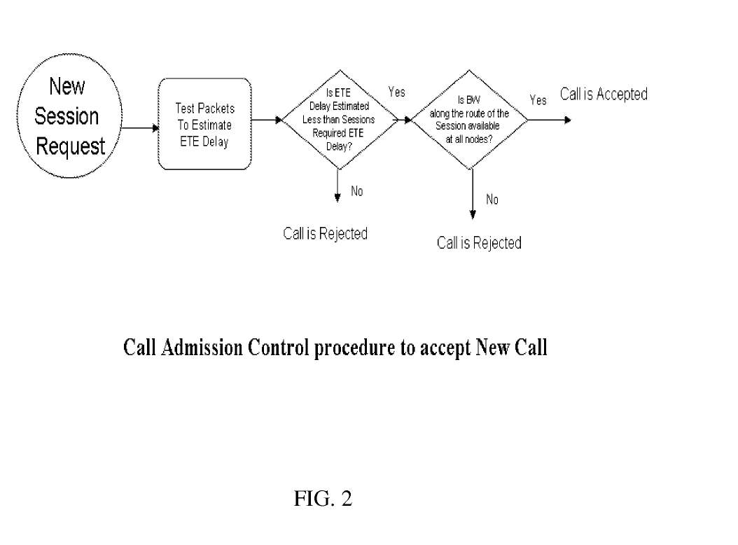

FIG. 2 shows a flow chart of the logic used by Call Admission Control (CAC) to grant a new connection for a QoS call.

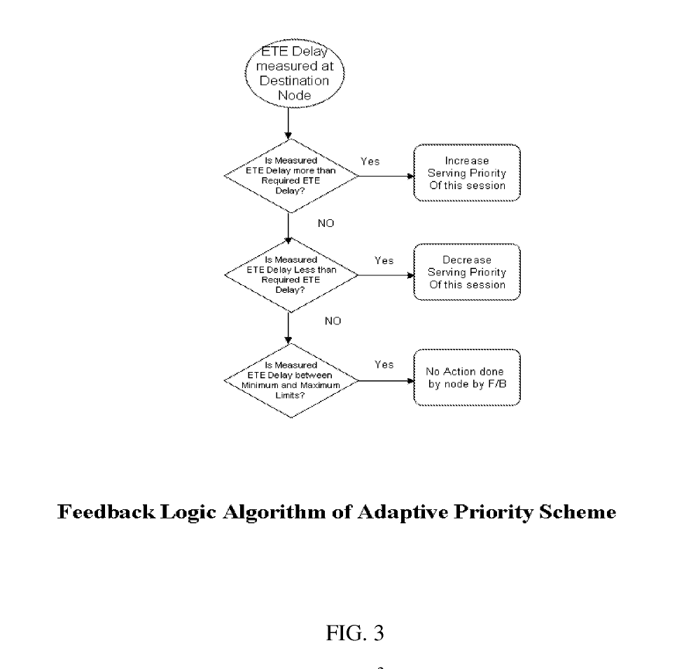

FIG. 3 shows flow diagram of logic used by nodes to adapt the serving or scheduling priorities of a session.

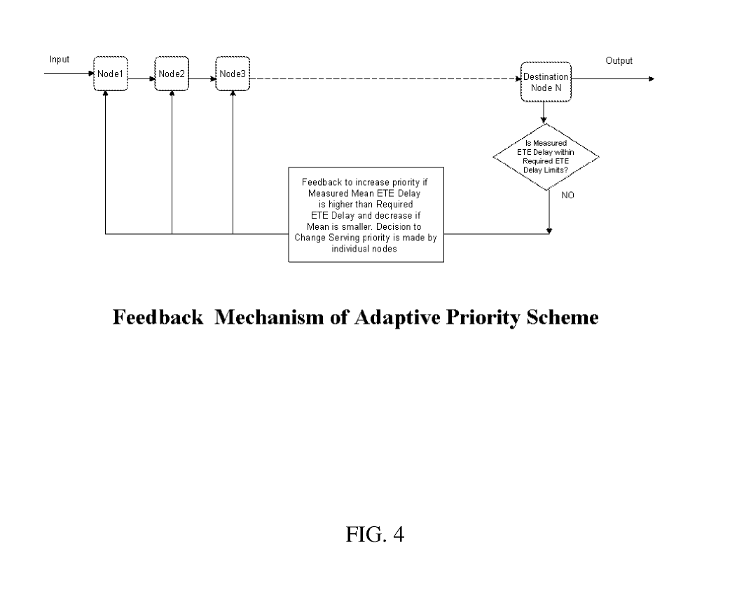

FIG. 4 shows a block diagram of the condition under which destination node sends feedback signal to the previous nodes along the route of the session to take some action.

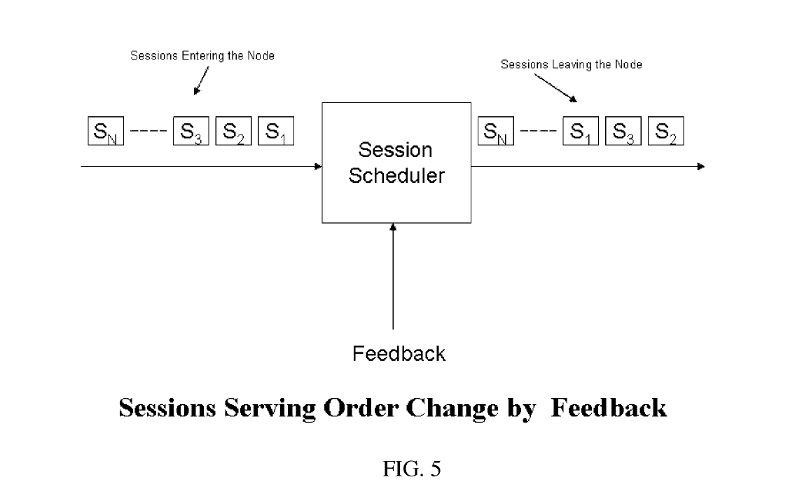

FIG. 5 shows a diagram that based upon the feedback input, how the serving order of QoS sessions can change.

### DETAIL DESCRIPTION OF INVENTION

This section describes the Feedback Controlled Adaptive Priority Scheme in detail. Before we present the full architecture of our adaptive priority scheme, it is essential that we define certain terms.

### 1. Definitions

Test Packet: A test packet is similar to a ping or trace-route IP packet that will be sent before a connection is accepted in order to estimate the queuing delays of the new connection at different nodes of the route of the connection. The test packets also record the available QoS bandwidths at the different node they pass through.

QoS-Traffic Ratio: QoS-traffic ratio is the ratio of maximum QoS rate allowed on an interface to the maximum physical bandwidth of the interface. The network administrator decides this ratio, with which he or she wants to mix QoS and non-QoS traffics. Once the traffic ratio is fixed, QoS traffic limits are determined, and no node can accept a new connection, which can violate its QoS limit. However, this traffic ratio does not put any constraint on accepting non-QoS traffic, so it is possible that a node could be overbooked with extra non-QoS traffic. The basic idea is that if at any time a QoS session needs extra bandwidth, network should halt non-QoS traffic at that interface and provide that bandwidth to the QoS traffic. QoS-traffic ratio can be written as follow.

$${Ratio}_{Q} = \frac{{\sum }_{i = 1}^{{J}_{Q}} λ ( i )}{BW}$$

where
Ratio_{Q}=QoS traffic ratio
λ(i)=Rate of arrival of i^{th} session
J_{Q}=Total number of QoS sessions at the interface
BW=Maximum Physical Bandwidth of the interface

Reference Delay: After knowing the queuing delays test packets experience, we can divide the required ETE delay of the session in proportion to queuing delays of test packets. We refer these delays as Reference Queuing Delays or simply Reference Delays. The reason we call these as reference delays is; if a session maintains its queuing delays at these reference values, its ETE delay will remain in limits.

### 2. Architecture of Adaptive Priority Scheme

The objective of the new scheme is to control ETE delay. The idea is to serve every QoS session at every node with a priority such that its ETE delay remains within its requirement limits.

### The Key Concept Behind the New Architecture

Theory behind the scheme is, if we can maintain the reference delays of the session at the same level which Test Packets experienced, ETE delay will remain bounded within ETE delay limits. This is done with the help of Feedback, which advises nodes to adapt their scheduling priorities in such a way that ETE delay remains bounded in ETE delay limit of the session.

### Main Components of the Architecture

The scheme architecture has following main components:
i. Connection Admission Control (CAC)
ii. Estimation of Reference Delays
iii. Adaptive Priority Scheduling
iv. Feedback Control Mechanism
   A schematic diagram of the scheme is shown in FIG. 1

### 2.1 Connection Admission Control (CAC)

New QoS connection is granted by Call Admission Control (CAC) on a route where Test Packets can reach destination within the ETE Delay requirement of QoS session. In addition to that BW required for QoS session should not cause QoS-Traffic Ratio violation at any node along the route of the session. In other words Call Admission Control must verify at least the following two conditions:
1. If the mean ETE delay of test packets is less than the desired ETE delay, the connection is accepted; otherwise, it is rejected. That is,

Mean ETE Delay of Test Packets<Required ETE Delay of New Session (I)
2. New connection should not cause any node to increase its maximum QoS traffic limit as set by QoS Traffic Ratio

Total QoS Arrival Rate<Maximum QoS Limit of the Node (II)

where Maximum QoS Traffic Limit is defined by QoS Traffic Ratio

### 2.2 Estimation of Reference Delays

As discussed before Reference Delays are estimated by Test Packet procedure.

### Minimum and Maximum Reference Delay Assignment

After assigning the reference delay of a session j at a node i, we have enough information about the application to assign the minimum and maximum reference delay limits. The need to define minimum and maximum Reference Delay limits is, to know how far we can change the priorities of a particular QoS session. We know the average rate or bandwidth the application is looking for, we know the minimum bandwidth requirements of the application and we also know maximum bandwidth an interface can provide a session in worst case scenario. We use this information with the following algorithm to calculate minimum Reference Delay (RDmin) and maximum Reference Delay (RDmax) of a session. We calculate the product of reference delay and bandwidth of the QoS session.

RD[i, j]×BW[i, j]=Kᵢⱼ (1)

where
Kᵢⱼ=Reference delay-bandwidth constant of j^{th} session at i^{th} node

Let BWₘᵢₙ[i,j] and BWₘₐₓ[i,j] represent the minimum and maximum bandwidth requirements of QoS Session j. Logically BWₘₐₓ[i,j] can be the entire physical bandwidth of the interface. Then in these terms we can define RDₘₐₓ[i,j] RDₘᵢₙ[i,j] as follow

$${RD}_{min} [ i , j ] = \frac{{K}_{ij}}{{BW}_{max} [ j ]} \qquad ( 2 )$$

and

RDₘₐₓ[i, j]=RD_{NQ} (3)
Where RD_{_{—}}_{NQ} is defined as Reference Delay of Non-QoS session
   It should be noted that BWₘₐₓ[i, j ] in (1) is very high compared with Kᵢⱼ, so practically RDₘᵢₙ[i, j], or minimum reference delays of all QoS sessions become same.

### 2.3 Adaptive Priority Scheduling

Now we have Reference Delay values for QoS session at every node of its route which are unique, hence we can assign set of unique serving priorities or serving order for that QoS session. Rule to assign serving priorities can be as simple as session with minimum Reference Delay will be served first or can be little complicated. Main thing is we have unique value of delay for every single session, so we can assign a unique Serving Priority to every single QoS session at every node it is passing through. Hence we claim that

Pr [i, j]=f (RD [i, j]) (4)

### Where

Pr[i.j]=Serving Priority of j^{th} Session at i^{th} Node
   and
RD[i.j]=Reference Delay of j^{th} Session at i^{th} Node

Hence in the rest of this document, we will only show mechanism, how we can adapt Reference Delays of QoS sessions and if we can do so, this would mean that we can adapt the serving priorities of that session.

### Serving Priority Rule

For sake of simplicity we choose a very simple priority assigning rule and our rule is: session with shortest Reference Delay value should be served First. It should be noted that when we change the Reference Delay of a session, it changes the serving priorities of not one but all the packets of that session.

### 2.4 Feedback Control Mechanism

After we assign initial reference delays or priorities to a QoS session, if a QoS session does not misbehave, these scheduling priorities will serve the QoS session without violating its ETE delay demand. In case if some QoS session misbehaves or if some QoS session increases its pre-estimated rate, then these kinds of situations are controlled by the feedback mechanism. Main components of this section are:
i. Definitions
ii. Measurements and Calculations of ETE and Queuing Delays
iii. Reference Delay Adaptive Algorithms

### 2.4.1 Definitions

Before we go further, let's define some terminology to better the feedback architecture.

### Upper and Lower Threshold ETE Delays of a QoS Session

When ETE delay of a QoS session increases to a certain predefined limit, the destination node sends feedback message to the previous nodes of the route to take action to reduce the ETE delay of the session. That limit of ETE delay at which a destination node sends a signal to the previous nodes is called the upper threshold of ETE delay.

Similarly the limit after which further decrease in reference delay may affect the quality of other QoS sessions, the destination node sends a feedback signal to the previous nodes to increase reference delays of the session. That limit is called the lower threshold of ETE delay. It should be noted that these threshold limits are user-defined.

### Feedback Loop Interval

The feedback loop interval is the interval in which an application sends a fixed number of packets to its destination. It should be noted that the feedback interval does not have to be the same for every session. Also, applications doesn't need to use the default interval value provided by network. Feedback interval has two components, observation interval and advertising interval.

### Observation Interval

In an observation interval, every intermediate node of the route keeps on measuring queuing delays, while destination node keeps on measuring ETE delay of packets. These measurements are tracked on per session basis. Intermediate nodes measure queuing delay of every packet of the session during observation interval and at the end of the observation interval, every intermediate node calculates the mean queuing delay. Similarly at the end of observation interval destination node calculates the mean ETE delay.

### Advertising Interval

The advertising interval is the interval in which a destination node advertises the mean ETE delay of a session it calculated during observation interval to the previous hops of the route. The sum of these two intervals is equal to the feedback interval or feedback loop interval.

Feedback Interval=Observation Interval+Advertising Interval

### 2.4.2 Measurement and Calculations of ETE and Queuing and Delays

Since the scheme is based on measurements, it is essential to measure the queuing and ETE delays. Some measurements and calculations are performed at the destination node, while some are done at every individual node of the route of a QoS session.

### Measurement and Calculations of ETE Delays

The destination node of a session measures ETE delay during an observation interval:

ETE [j,k]=SFT[j,k]at Destination Node−PGT[j,k]

where
j=Session number
k=Packet number
SFT[j, k]=Service finish time of k^{th} packet of j^{th} session
PGT[j,k]=Packet generation time of k^{th} packet of j^{th} session
   Mean ETE delay is calculated based on the total number of packets served in the observation interval.

$$METED [ j ] = \frac{{\sum }_{k = 0}^{{K}_{OI}} ETED [ j , k ]}{{K}_{OI}} \qquad ( 5 )$$

where
K_{OI}=Total number of packets served by the destination node during the observation interval.

### Measurement and of Mean Queuing Delay

Queuing delays are measured for every packet at every intermediate node in the route of a session. In order to do that, we subtract packets' service finish times at every node from the packet generation time.

QD[i, j, k]=SFT[i, j, k]−PAT[i, j, k]

where
i=Node number,
j=Session number
k=Packet number
PAT[i,j,k]=Packet arrival time of k^{th} packet of j^{th} session at i^{th} node
QD[i,j,k]=Queuing delay of k^{th} packet of j^{th} session at i^{th} node
   This gives the queuing delay of the packet at a node. During the observation interval, we keep on measuring the queuing delays of all of the packets of a session. The mean queuing delay of all of the packets in a QoS session is given by

$$MQD [ i , j ] = {\sum }_{k = 0}^{KL} \frac{QD [ i , j , k ]}{No . \_Of \_Pkt \_Svd [ j ]} \qquad ( 6 )$$

where
i=Node number
j=Session number
k=Packet number
KL=Packets served in a feedback loop interval
No._Of_Pkt_Svd[j]=Number of j^{th} session's packets served
MQD[i,j]=Mean queuing delay of QoS session j at i^{th} node

### 2.4.3 Reference Delay Update Algorithms

After calculating the mean queuing delay of a session and after getting feedback input about the mean ETE delay, a node can calculate the new reference delay of a QoS session. If we look at the mean ETE delay of a QoS session, there can be only three possibilities:
i. Mean ETE delay is higher than the upper threshold
ii. Mean ETE delay is lower than the lower threshold
iii. Mean ETE delay is between the upper and lower thresholds
   We will discuss all three cases one by one.
   Case1: Mean ETE Delay is higher than the Upper Threshold

In this section, we will analyze, how Reference Delays and bandwidths are adapted if mean ETE delay measurement at the destination node is higher than upper threshold of ETE delay.

### Reference Delay Update

Let
METED[j,n−1]=Mean ETE delay of session j observed in (n−1)^{th} loop
ETED_{TH}_{_{—}}ᵤₚ[j]=Upper threshold value of ETE delay of session j

### If

METED[j,n−1]>ETED_{TH}_{_{—}}_{UP}[j] (7)

Then we calculate change in reference delay “ΔRD” for the packets of j^{th} session at i^{th} node as follows:

$$Δ RD [ i , j , n ] = \{ \frac{METED [ j , n - 1 ] - {ETED}_{TH \_ UP} [ j ]}{METED [ j , n - 1 ]} \} \cdot ( {RD}_{max} [ i , j ] - {RD}_{min} [ i , j ] \cdot FB\_RD \_SC \qquad ( 8 )$$

where
ΔRD [i, j, n]=Change in reference delay requested in the next or n^{th} loop of session j at node i.
ETED_{TH}_{_{—}}_{UP}[j]=Threshold value of ETE delay of session j
RDₘₐₓ[i,j]=Maximum reference delay of session j at node i
RDₘᵢₙ[i,j]=Minimum reference delay of session j at node i
FB_RD_SC=Feedback reference delay scaling factor

This scaling factor scales reference delay change down or up as desired. Its normal value is equal to 1. If the condition in Equation (7) is fulfilled, then we check to see whether the reference delay of session j fulfills the following condition:

RD[i, j, n−1]−ΔRD[i, j,b]>RDₘᵢₙ[i, j] (9)

If the conditions in Equations (7) and (9) are fulfilled, then we can reduce the reference delay for session j for the next loop. It should be noted that Equation (7) tells that reference delay of the session j should be reduced while Equation (9) ensures the lower bound of the reference delay is not crossed. If lowering the reference delay lower bound is not violated, then it is safe to reduce the reference delay. Then new reference delay of session j will be:

RD[i, j, n]=RD[i, j, n−1]−ΔRD[i, j, n] (10)

If the condition in Equation (9) is not fulfilled, we check for the following condition:

$${\sum }_{p = 0}^{p = j - 1} \frac{{K}_{ip}}{RD [ i , p , n - 1 ]} + \frac{{K}_{ij}}{( RD [ i , j , n - 1 ] - Δ RD [ i , j , n ] )} + {\sum }_{p = j + 1}^{p = n} \frac{{K}_{ip}}{RD [ i , p , n - 1 ]} \qquad ( 11 )$$

<Total. QoS Arrival Rate for that Load
where Kᵢⱼ and Kᵢₚ are reference delay-bandwidth product as defined in Equation (1)

Please note that the first term

$${\sum }_{p = 0}^{p = j - 1} \frac{{K}_{ip}}{RD [ i , p , n - 1 ]}$$

is the sum of the “j−1” sessions' bandwidths during the (n−1)^{th} feedback interval. All these (j−1) sessions have serving priorities higher than serving priority of the j^{th} session.

The second term,

$$\frac{{K}_{ij}}{( RD [ i , j , n - 1 ] - Δ RD [ i , j , n ] )}$$

is the increase in bandwidth of the j^{th} session requested by feedback for the n^{th} interval.
The third term

$${\sum }_{p = j + 1}^{p = n} \frac{{K}_{ip}}{RD [ i , p , n - 1 ]}$$

is the sum of bandwidths in (n−1)^{th} feedback interval of all QoS sessions whose serving priorities are lower than the serving priority of j^{th} session. Hence, the left side of inequality is the sum of the bandwidths of all active QoS sessions and the increase of bandwidth of the j^{th} QoS session for the next interval. If this condition is satisfied, then this would mean that increasing rate of j^{th} priority not hurt any higher than j^{th} priority. Under that scenario, we will allow reference delay to be reduced for one loop interval. Hence, reference delay expression for session j at i^{th} node can be written as:

$$\begin{matrix}RD [ i , j , n ] = RD [ i , j , {n}^{′} - 1 ] - Δ RD [ i , j , n ] for {n}^{′} = n \\ = RD [ i , j , n - 1 ] for {n}^{′} > n\end{matrix} \qquad ( 12 )$$

This condition allows feedback to grant the misbehaving session extra bandwidth for the limited time of one feedback loop.

Note that this bandwidth increase is also limited to one node only. The next hop may or may not grant this bandwidth to this misbehaving session depending on whether the condition of Equation (11) is fulfilled or not. So if an application sends a burst of data at a rate higher than its peak rate, it can only pass through all of the nodes along the route if and only if every node has free bandwidth available.

If the condition in Equation (7) is fulfilled but the conditions in Equations (9) and (11) are not fulfilled, then feedback keeps the reference delay of the session at the original value because this session must be misbehaving, and accepting its request may cause disturbance in the QoS of other sessions. In other words, under that scenario,

RD[i, j, n]=RD[i, j, n−1] (13)

### Bandwidth Update

Corresponding change in the bandwidths of session j are given by

$$Δ BW [ i , j , n ] = \frac{{K}_{ij}}{RD [ i , p , n - 1 ]} - \frac{{K}_{ij}}{RD [ i , j , n ]} \qquad ( 14 )$$

where
Kij=Reference delay bandwidth constant oft session at i^{th} node
   This can be written as

$$Δ BW [ i , j , n ] = \{ \frac{Δ RD [ i , p , n - 1 ]}{RD [ i , j , n ]} \} \times BW [ i , j , n - 1 ] \qquad ( 15 )$$

BW[i, j, n]=BW[i, j, n−1]+ΔBW[i, j, n] (16)

where
ΔBW[i,j,n]=Change in bandwidth of j^{th} session at i^{th} node in n^{th} loop
BW[i,j,n]=New bandwidth of j^{th} session at i^{th} node in n^{th} loop
   Case2: Mean ETE Delay is Lower than Lower Threshold

In this section, we will analyze, how reference delay and bandwidths are adapted if mean ETE delay is lower than lower ETE threshold.

### Reference Delay Update

If

METED[j,n−1]<ETED_{TH}_{_{—}}_{Low}[j] (17)

where
METED[j,n−1]=Mean ETE delay of session j observed in (n−1)^{th} loop
   and
ETED_TH_Low[j]=Minimum threshold value of ETE delay of session j then the change in reference delay of session j at i^{th} node by feedback system will be

$$Δ RD [ i , j , n ] = \{ \frac{{ETED}_{TH \_ Low} - METED [ j , n - 1 ]}{METED [ j , n - 1 ]} \} \cdot ( {RD}_{max} [ i , j ] - {RD}_{min} [ i , j ] \cdot FB\_RD \_SC \qquad ( 18 )$$

If the condition in Equation (17) is fulfilled, then we check whether the reference delay of session j for the next loop fulfills the following condition:

RD[i, j, n_{—}1]+ΔRD[i, j, n]<RDₘₐₓ[i, j] (19)

If the conditions in Equations (17) and (19) are fulfilled, then we increase the reference delay of session j for the next loop using the following:

RD[i, j, n]=RD[i, j, n−1]+ΔRD[i, j, n] (20)

If the condition in Equation (17) is fulfilled but the condition in Equation (19) is not fulfilled, then we'll keep the reference delay of the session at its original value, because this QoS session is sending data at minimum rate. In other words,

RD[i, j, n]=RD[i, j, n−1] (21)

Note that increasing reference delay beyond the RDₘₐₓ limit won't do any good, because RDₘₐₓ is an indication, that bandwidth assigned to the session is at its minimum. If this session doesn't use that minimum bandwidth, there is no harm, because the scheduler will pick up the next non-QoS session's packet to serve in its place if it doesn't find a QoS packet. Since there is no loss of bandwidth, there is no need to reduce it further.

### Bandwidth Update

Corresponding changes in bandwidths (BW) of session j are given by

$$Δ BW [ i , j , n ] = \{ \frac{Δ RD [ i , j , n ]}{RD [ i , j , n - 1 ]} \} \times BW [ i , j , n - 1 ] \qquad ( 22 )$$

or

BW[i,j,n]=BW[i,j,n−1]−ΔBW[i,j,n] (23)

Case 3: When Actual ETE Delay is between Lower and Upper Thresholds

If

ETED_{TH}_{_{—}}_{Low} [j]<METED[j,n−1]<ETED_{TH}_{_{—}}_{UP}[j] (24)

then this means that the session is meeting its ETE delay requirement, and there is no need to adapt the reference delay or bandwidth of QoS session

RD[i, j, n]=RD[i, j, n−1] (25)

### 3. Conclusion

What we conclude here is, we have developed mechanism, to adapt Serving or Scheduling priority of QoS sessions to control their ETE delays.

The main achievement of the scheme is the invention of the control parameter “Reference Delay”. This single control parameter alone can control most of QoS parameters. A proper control of reference delay
i. Sets a priority according to which a QoS session will be served.
ii. Controls the queuing delay on per session base.
iii. Can control the bandwidths of each QoS session.
iv. Causes a non-QoS session to lose packets if necessary to preserve QoS packets.

1. Independent Claim
There are following three independent claims:
1. One main independent claim is that idea of controlling ETE delay of QoS sessions in Feedback Controlled Adaptive Priority Scheme, using Feedback Control System and Reference Queuing Delays is new. The idea as well as the architecture of the scheme we presented here have never been used before.
2. The second independent claim we make here is that the scheme can be used for planning the capacity of network in a unique way. During call admission process, if a connection fails due to bandwidth unavailability on a particular router, then based on this we can increase bandwidth on that particular router interface which caused the call to fail.
3. The third independent claim we make here is: In the scheme we invented, QoS Traffic Ratio is a parameter which limits QoS traffic at every node. If this ratio is small, this means that at every node there is lot of bandwidth used by Non-QoS traffic which can be sacrificed for QoS traffic in case QoS traffic is getting delayed. Since this parameter is fully controllable by Network Administrator and he or she can pick up any value for his/her network and Connection Admission Control (CAC) accordingly has to place number of calls/sessions on any interface, one can select low value of QoS Traffic Ratio for extremely delay sensitive QoS traffic such as radar data and higher for relatively less delay sensitive QoS traffic such as voice etc., and so on. Hence, this way a single parameter can control QoS traffic in entire network and if needed, network can be classified based on this traffic ratio for particular type of traffic. Now if we go a step further we note that, typically the routers, which are at the periphery of the network, are not as important as the core routers, because if a peripheral router gets congested or fails, it will cause only a few users to suffer. However, if a core router gets congested, it may affect almost all the users in the network. In order to protect core routers against getting congestion, a network administrator can simply assign a lower QoS-Traffic Ratio to core routers than to other routers. This will prevent core routers from being congested. Thus our scheme avoids bottleneck of QoS traffic at core routers because nodes can not exceed its preset QoS traffic limit. We claim that this mechanism of controlling bottleneck in networks by choosing appropriate QoS Traffic Ratio is also unique in our scheme

2. Dependent Claims
There are five independent claims as follow:
1. Feedback Controlled Adaptive Priority Scheme we invented, provides control not only to class-level but individual user or session level.
Now why this is a dependent claim? This become obvious if we review Feedback Controlled Adaptive Priority Scheme as discussed in “ Detail Description of Invention”. In all the parameters we used in scheme, such RD[i,j,k], ETE [i,j] etc., variable “j” represents a unique session number. Hence if we claim that scheme controls ETE delay on individual session level, it is not new, it is already we have implemented in the scheme. All we saying here is, no one else has controlled ETE delay on session level, the way we have controlled.
2. Method of assigning and adapting serving priorities based on their Reference delays as used in our scheme, is unique. No other scheme have used this algorithm to adapt the scheduling priorities.
Now why this is a dependent claim? Again if we look at Feedback Controlled Adaptive Priority Scheme as discussed in “ Detail Description of Invention”, scheme is developed on the concept of a “Reference Delay” The idea is every session should be assigned a reference queuing delay at the beginning and throughout it should maintain it. Without defining “Reference Delay” scheme cannot be implemented. Please see subsection “Key Concept Behind the New Architecture” under Section 2 of “ Detail Description of Invention
3. Scheme choose multiple serving priorities of same QoS session at different nodes and this characteristic is unique to our “Feedback Controlled Adaptive Priority Scheme”. Other Priority schemes when assign a priority it remains same for all the nodes.
The reason this is not an independent claim can easily be established even from title of the scheme which starts with “ Adaptive Priority Scheme . . . ” because scheme adapts priorities of each QoS session from node to node and even at the same node depending upon how it can control the ETE delay. Without adapting or changing priorities we can not control delay. Look at Equation (8) and (18) in Sec 2.4.3 which give formulae to adapt or change scheduling priorities.
4. We claim that, if there are multiple sessions in same priority class (such as in the highest priority class) and each of these sessions have different ETE delay demands, then our scheme have ability to serve each and every single of these sessions within their ETE delay requirements.
The reason for this claim be a dependent claim is very simple because this is one of the fundamental feature of the scheme that it provides priority on session level, while other scheme provide control on priorities on class level. One class can have multiple sessions. Such as voice class can have multiple phone call sessions at same time but since we are identifying each of such sessions by a unique session number “j”, we treat each session separately and control each session separately. This is we have also said in dependent claim number 1.
5. Mechanism provided to control ETE delay of QoS traffic in our invention does not depend on layer 2 protocols to control QoS as it is done in MPLS, SVC/PVC and most of other cases. In other words it is a layer 2 independent protocol.
Again this claim is a dependent on independent claim No. 1 because scheme presented in independent claim does not make use of any layer 2 protocols such as Data Link Control Protocols (DLCP) or its variants such as Frame Relay or ATM etc. Hence if main scheme is an independent claim then this particular claim is dependent on it. In other words this claim has no use if main scheme is not deployed.
